(19) United States
(12) Patent Application Publication
(10) Pub. No.: US 2011/0036126 A1
(43) Pub. Date: Feb. 17, 2011

(54) Laundry treatment machine comprising a device for determining the weight of a load

(75) Inventors: Stephan GERSTER, Wachtberg-Pech (DE); Albrecht STAHL, Sulzbach (DE); Michael SCHURR, Murrhardt (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: SOEHNLE PROFESSIONAL GMBH & CO. KG, Backnang (DE)

(21) Appl. No.: 12/854,941

(22) Filed: Aug. 12, 2010

(30) Foreign Application Priority Data
Aug. 14, 2009 (DE) 10 2009 037 301.2

(51) Int. Cl. D06F 33/00; G01G 19/52

(52) U.S. Cl. 68/12.04; 177/132

(57) ABSTRACT

A laundry treatment machine includes a load determining device configured to determine a weight of a load disposed inside the machine. The load determining device includes a first force measuring device configured to sense a total weight of the machine with objects disposed therein and thereon, and a second force measuring device configured to sense a weight of the object disposed on the machine.

### CROSS REFERENCE TO PRIOR APPLICATION

Priority is claimed to German Application No. DE 10 2009 037 301.2, filed Aug. 14, 2009, the entire disclosure of which is incorporated by reference herein.

### FIELD

The invention relates to a laundry treatment machine, in particular a washing machine or a laundry dryer, comprising a device for determining the weight of a load placed inside the laundry treatment machine.

### BACKGROUND

A device for measuring the loaded amount and corresponding dosage in washing machines is described in DE 89 05 565.9 U1. It is suggested that a weighing arrangement be provided in the washing machine feet for detecting the weight in the washing machine region which is changed by the material to be put inside and that the signals thereof be fed to a central electronic control circuit. This device has the enormous disadvantage that the measurement is unintentionally distorted owing to the fact that the user places objects, for example washing utensils, permanently or temporarily on the washing machine.

### SUMMARY

Therefore, an aspect of the present invention is to provide a laundry treatment machine comprising a device for determining the weight of a load which will, in a simple manner, make it possible to determine the weight of a load in a reliable and undistorted manner.

In an embodiment, the present invention provides a laundry treatment device. A laundry treatment machine includes a load determining device configured to determine a weight of a load disposed inside the machine. The load determining device includes a first force measuring device configured to sense a total weight of the machine with objects disposed therein and thereon, and a second force measuring device configured to sense a weight of the object disposed on the machine.

### BRIEF DESCRIPTION OF THE DRAWING

The subject-matter of the invention is shown schematically in the drawing and is described below with reference to the figures, members having like functions being provided with like reference numerals. In the figures:

The single FIGURE shows a laundry treatment machine.

### DETAILED DESCRIPTION

The laundry treatment machine according to the invention has the advantage that it is possible to reliably determine the weight of the load regardless of whether or not the user of the laundry treatment machine places objects on the laundry treatment machine—be this only a clothes peg. Advantageously, it is even possible to place a further laundry treatment machine on the laundry treatment machine according to the invention—for example, to place a laundry dryer on a laundry treatment machine according to the invention—without the function of determining the weight of the load being compromised.

In a particular embodiment of the laundry treatment machine according to the invention, it is provided that the device for determining the weight of the load detects the total weight of the laundry treatment machine, together with objects located therein and thereon, and subtracts therefrom the weight of objects placed on the laundry treatment machine.

In particular, it may be provided that the first force measuring device produces first electronic measurement signals and that the second force measuring device produces second electronic measurement signals. The electronic measurement signals may be analogue or digital measurement signals. In particular, it may be provided that the device for determining the weight of the load electronically subtracts the second measurement signals from the first measurement signals. This may take place via an analogue subtraction circuit, for example. However, it is also possible to process digital signals in a manner involving subtraction.

In a particularly advantageous embodiment of the laundry treatment machine according to the invention, it is provided that the laundry treatment machine controls the selection and/or the execution of a laundry treatment programme and/or an addition amount and/or laundry treatment parameters as a function of a detected loading weight or as a function of a time characteristic of detected loading weight. This embodiment has the particular advantage that an entirely precise adaptation of the treatment parameters and the addition amounts and the treatment times may take place. The laundry treatment time may thus be reduced on the one hand, and in addition laundry preservation may be made possible and energy may be saved. In this regard, the addition amount may concern, for example, an amount of detergent and/or an amount of water and/or an amount of fabric softener just as obviously as the weight of the laundry to be treated itself, it being possible for pre-programmed specific weights of individual components to enter into the detection. In a manner according to the invention, the laundry treatment machine may control, as a function of the detected load or as a function of the time characteristic of the detected load, for example a washing or drying temperature or a rotational speed of a drum or a duration of a treatment as laundry treatment parameters.

In an embodiment of the laundry treatment machine according to the invention which is particularly robust and cost-effective to produce, the first force measuring device comprises at least one first force sensor—preferably at least three force sensors. This or these may, for example, be formed as supporting feet or be arranged between the supporting feet and a housing or a base plate. In addition, it may be provided that the second force measuring device comprises at least a second force sensor and a cover borne by this, wherein the cover may close the entire device at the top in a delimiting manner.

In an advantageous embodiment, the first force measuring device comprises four force sensors formed as supporting feet. In addition, at least three second force sensors are provided which bear a cover delimiting the laundry treatment machine at the top, without the cover resting on further structural components.

The laundry treatment machine according to the invention makes it possible to determine not only the weight of laundry items placed inside it, but also the weight—and thereby, at least indirectly, the amount—of (supplied) water introduced and also makes it possible to determine the weight of detergent or fabric softener introduced, in particular if these components are introduced from an external reservoir or via external supply pipes.

In addition, it is obviously also possible for the device also to detect the weight of an efflux of wash water and the amount of the drained wash water, for example in order to control the selection or the execution of a laundry treatment programme.

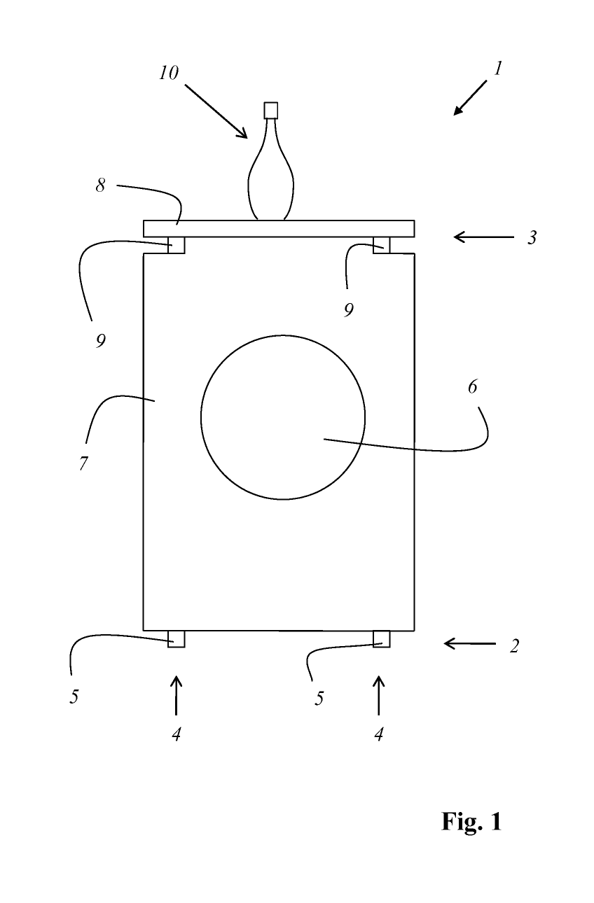

FIG. 1 shows a laundry treatment machine 1 according to the invention comprising a device for determining the weight of the load, which comprises a first force measuring device 2 and a second force measuring device 3. The first force measuring device 2 includes four first force sensors 4 which are formed as supporting feet 5 and interconnected in such a manner that they produce one measurement signal, which is proportional to the total weight of the laundry treatment machine (without the weight of the standing feet) together with objects located therein and thereon. The laundry treatment machine 1 comprises a loading aperture 6 through which laundry items can be introduced. In addition the laundry treatment device 1 comprises a housing 7, which is delimited at the top by a cover 8. The cover 8 is borne exclusively on second force sensors 9 of the second force measuring device 3. An object, namely a bottle of detergent 10, is placed on the cover merely by way of example, the weight of which object is detected by the second force measuring device 3 insofar as it produces measurement signals which are proportional to the weight of this object. The device for determining the weight of the load electronically subtracts the measurement signals produced by the second force sensors 9 from the measurement signals produced by the first force sensors 4, in order to generate a measurement signal which is dependent exclusively on the weight of the load—not on the weight of the objects placed on the cover 8. A feed hose for water is not shown, although it is also possible to detect a load produced by inflowing water.

The invention has been described with reference to a particular embodiment. However, it is obvious that variations and modifications may be made without departing from the scope of protection of the following claims.

### LIST OF REFERENCE NUMERALS

1 laundry treatment machine
2 first force measuring device
3 second force measuring device
4 force sensor
5 supporting feet
6 loading aperture
7 housing
8 first force sensor
9 second force sensor
10 bottle of detergent

1-15. (canceled)

16. A laundry treatment machine comprising:
a load determining device configured to determine a weight of a load disposed inside the machine, the load determining device including:
a first force measuring device configured to sense a total weight of the machine with objects disposed therein and thereon, and
a second force measuring device configured to sense a weight of the object disposed on the machine.

17. The laundry treatment machine as recited in claim 16, wherein the machine is at least one of a washing machine and a laundry dryer.

18. The laundry treatment machine as recited in claim 16, wherein the load determining device is configured to subtract a weight of the objects disposed on the laundry machine from the total weight of the machine with the objects disposed therein and thereon.

19. The laundry treatment machine as recited in claim 16, wherein the first force measuring device is configured to produce a first electronic measurement signal and the second force measurement device is configured to produce a second electronic measurement signal.

20. The laundry treatment machine as recited in claim 19, wherein the first and the second measurement signals are analog signals.

21. The laundry treatment machine as recited in claim 19, wherein the first and the second measurement signals are digital signals.

22. The laundry treatment machine as recited in claim 19, wherein the load determining device is configured to subtract the second measurement signal from the first measurement signal.

23. The laundry machine as recited in claim 16, wherein the machine is configured to control at least one of a selection of a laundry treatment program, an execution of a laundry treatment program, an addition amount and a laundry treatment parameter as a function of the detected weight of the load.

24. The laundry treatment machine as recited in claim 16, wherein the machine is configured to control at least one of a selection of a laundry treatment program, an execution of a laundry treatment program, an addition amount and a laundry treatment parameter as a function of a detected loading weight as a function of time characteristic of the detected weight of the load.

25. The laundry treatment machine as recited in claim 23, wherein the addition amount corresponds to at least one of an amount of detergent, an amount of water and an amount of fabric softener.

26. The laundry treatment machine as recited in claim 24, wherein the addition amount corresponds to at least one of an amount of detergent, an amount of water and an amount of fabric softener.

27. The laundry treatment machine as recited in claim 23, wherein the laundry treatment parameter corresponds to one of a washing temperature, a drying temperature, a rotational speed of a drum and a duration of a treatment.

28. The laundry treatment machine as recited in claim 24, wherein the laundry treatment parameter corresponds to one of a washing temperature, a drying temperature, a rotational speed of a drum and a duration of a treatment.

29. The laundry treatment machine as recited in claim 16, wherein the first force measuring device includes at least one first force sensor.

30. The laundry treatment machine as recited in claim 16, wherein the second force measuring device includes at least one second force sensor.

31. The laundry treatment machine as recited in claim 29, wherein the at least one first force sensor has a form of supporting feet.

32. The laundry treatment machine as recited in claim 29, wherein the at least one first force sensor is disposed between supporting feet and a housing or a base plate.

33. The laundry treatment machine as recited in claim 16, wherein the second force measuring device includes a cover delimiting the machine at a top of the machine.

34. The laundry treatment machine as recited in claim 33, wherein the second measuring device includes at least one second force sensor configured to support the cover.

35. The laundry treatment machine as recited in claim 16, wherein the weight of the load corresponds to at least one of a weight of introduced laundry items, a detergent weight, a water weight and a care product weight.
